(19) United States
(12) Patent Application Publication
(10) Pub. No.: US 2018/0307861 A1
(43) Pub. Date: Oct. 25, 2018

(54) SYSTEM AND METHOD FOR AUTOMATICALLY ESTABLISHING, TRACKING, AND QUERYING THE TRUST LEVEL OF FILES, PATCHES, AND UPDATES

(71) Applicant: Robert Johnson, Merrillville, IN (US)

(72) Inventor: Robert Johnson, Merrillville, IN (US)

(21) Appl. No.: 16/016,642

(22) Filed: Jun. 24, 2018

Related U.S. Application Data
(63) Continuation-in-part of application No. 11/836,446, filed on Aug. 9, 2007, now Pat. No. 8,806,617.

(51) Int. Cl. G06F 21/64; G06F 8/65; G06F 8/71; G06F 17/30; G06F 21/57

(52) U.S. Cl. CPC G06F 21/64; G06F 8/65; G06F 8/71; G06F 2221/033; G06F 17/30106; G06F 21/57; G06F 17/30371

(57) ABSTRACT

A system and method for maintaining server data integrity by identifying and classifying changes, preemptively, that may occur due to operating system updates, or vendor software updates by creating an authoritative database of files and their associated attributes, such as hashes, that are associated with patches and updates from operating system vendors and other software vendors.

### CROSS REFERENCE TO RELATED APPLICATIONS

This is a continuation of U.S. patent application Ser. No. 11/836,446, filed on Aug. 9, 2007, now U.S. Pat. No. 8,806,617, which is a continuation of U.S. patent application Ser. No. 10/685,1.89, filed on Oct. 14, 2003, now abandoned.

### BACKGROUND

### 1. Field of the Invention

The invention generally relates to computer software and more specifically to a system and method for maintaining server data integrity.

### 2. Description of the Related Art

The content of servers such as those hosting Internet web-sites, or devices such as routers are often tampered with by hackers or viruses. In some cases, one or more files such as web pages are removed from the server, whereas in other cases, their content is modified. Present systems and methods are available to provide varying levels of protection to server or device content. In one example, the security system produces digital signatures of a web-site's content and once a day checks the tiles to see if the digital signature matches. If the digital signatures of the files do not match, then the system notifies a designated user such as an administrator that the site has been tampered with. However, the system does not repair or replace the file or files that were tampered with.

In another example, a software product fits between a web server and the Internet. Whenever a web user accesses content on the website under control of the software, the software checks the digital signatures of the pages being accessed to make sure they match with the digital signatures stored as the master for those files. If the digital signatures don't match, then the system displays a notice to the user indicating that the site is down or under repair. This approach ensures that web user does not see any content that was altered, but instead just receives a notification that the site is temporarily unavailable. In both scenarios, the problem is not resolved, but rather it is merely identified. A network or web-site administrator still must deal with the efforts involved in restoring the site to its previous state, either from a backup tape or other similar methods.

The problem with the present systems and methods have created a need for a more robust system and method for maintaining server data integrity and restoring content that was altered. The present inventor's prior concepts are directed toward meeting this need.

However, modern day operating systems may contain millions of files. Thus, if a few files are modified, there is a high probability that the user of the system will not know of the change. In fact, some changes to systems are appropriate and should be allowed to occur. An example of such changes are updates to the operating system, or vendor software updates. When these types of changes occur, it is not possible to easily differentiate them from other changes that may be caused by a virus, malware, or a malicious user.

Accordingly, there is needed a method to identify and classify changes, preemptively, that may occur due to operating system updates, or vendor software updates. This is ultimately achieved by creating an authoritative database of files and their associated attributes, such as hashes, that are associated with patches and updates from operating system vendors and other software vendors.

### SUMMARY

In one exemplary embodiment, the present invention comprises a system for maintaining server data integrity, said system comprising: a repository interface operative to make a copy of an original object and to store the object copy in a safe object storage, wherein the original object resides on a first server and the safe object storage resides a second server remote from the first server; a monitor agent interface operative to monitor the original object to detect a change in real time, said monitor agent interface further operative to classify a change as preauthorized or unknown in real time according to a set of predetermined rules and send a notification to the repository interface when the change is detected; wherein said repository interface is further operative to receive the notification from the monitor agent interface, identify an authorized change to the original object and automatically allow said change to the original object; said repository interface is further operative to receive the notification from the monitor agent interface, determine that an unknown change to the original object was unauthorized, and restore the original object on the first server using the object copy from the safe object storage in response to the change; wherein the repository interface is further operative to retain a copy of the changed object that can be reviewed after the object copy is restored from the safe object storage.

In another exemplary embodiment, the present invention comprises a method for maintaining server data integrity in an electronic data base, said method comprising: receiving a selection of at least one object to be protected; providing a set of rules for classifying changes said object as preauthorized or unknown; generating a baseline copy of the object and storing the baseline copy in a safe object storage, wherein the at least one object resides on a first server and the safe object storage resides a second server remote from the first server; monitoring the object in real time; detecting an unauthorized modification to the object in real time; classifying said modification as preauthorized or unknown pursuant to said predetermined set of rules; in response to detecting an unknown modification, retrieving the baseline copy of the object from the safe object storage, and replacing the modified object on the first server with the baseline copy of the object; in response to detecting a preauthorized modification, maintaining the modification of the object on the first server.

In another exemplary embodiment, the present invention comprises a computer implemented method of identifying and classifying changes to software, said method comprising the steps of: determining a regularly scheduled interval for validating the software; providing a collector agent; having the collector-agent read a configuration file having information selected from the group consisting of the method for retrieving patches (HTTP vs YUM vs APT-GET, etc), bounded time range of information for which to retrieve, vendor specific URls, and specific patches to exclude that specifies high level information and vendor product specific parameters about each vendor's software product for which information will be gathered; based on the collector configuration data, having the collector-agent connect to each vendor's patch/update distribution system via a communication medium such as the internet, to retrieve all of the patches/updates that have been generated by the vendor since the last polling interval; and having the collector agent communicate with the remote vendor's patch/update distribution system.

In another exemplary embodiment, the present invention comprises: a computer based system comprising: a Collector-Agent, Distributed on multiple secure servers both on premise and in the cloud; a FileInfo-Server, Distributed on multiple secure servers both on premise and in the cloud, having an API Server, a Web Query Interface, and a Local Cache; a Collector-DB (Distributed on multiple secure servers both on premise and in the cloud); a Licensing Manager (Distributed on multiple secure servers both on premise and in the cloud); a Hash-Scanner; a NIST-Uploader; and an Administrative Management Subsystem.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 is a diagrammatic view of a computer system of one embodiment of the present invention.

FIG. 2 is a schematic diagram of one embodiment, demonstrating the steps and processes involved in monitoring and repairing altered content.

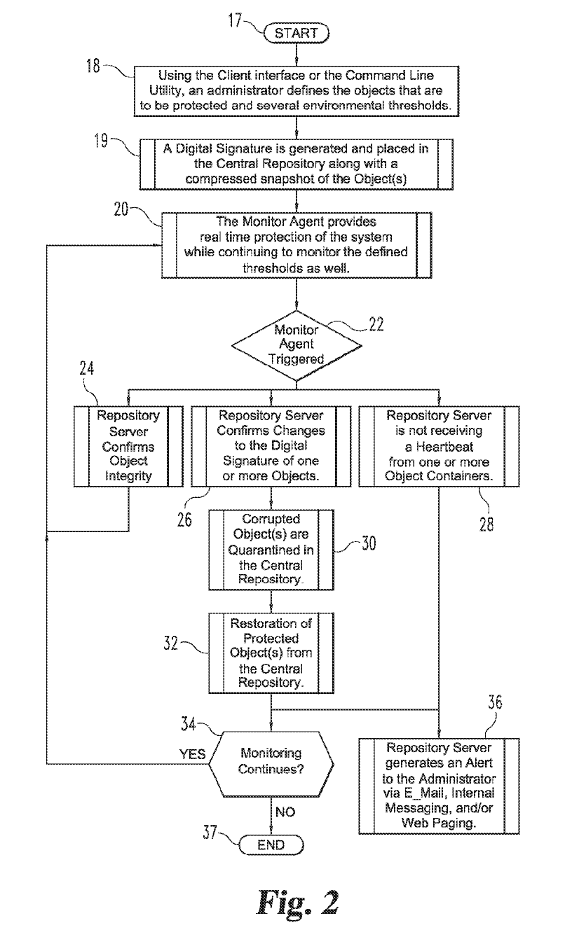

FIG. 3 is a schematic diagram of a monitoring component of one embodiment, demonstrating the steps and processes involved with monitoring the website in real time.

FIG. 4 is a schematic diagram of a platform independent object manager of one embodiment, demonstrating the steps and processes involved in monitoring objects on different platforms.

FIG. 5 is a schematic diagram of a site synchronization component of one embodiment, demonstrating the steps and processes involved in comparing the stored baseline of the protected objects against the actual protected objects.

FIG. 6 is a schematic diagram of an object action determination component of one embodiment, demonstrating the steps and processes involved in receiving messages from the monitor agent and passing them to the repository server.

FIG. 7 is a schematic diagram of a system integrity server of one embodiment, demonstrating the steps and processes involved in receiving and processing messages.

FIG. 8 is a schematic diagram of a server handshaking component of one embodiment, demonstrating the steps and processes involved with receiving and processing a handshake message.

FIG. 9 is a schematic diagram of a server SQL input/output (I/O) component of one embodiment, demonstrating the sets and processes involved in processing a SQL I/O message.

FIG. 10a is a schematic diagram of a first portion of a server file input/output (I/O) component of one embodiment, demonstrating the steps and processes involved in processing file I/O messages.

FIG. 10b is a schematic diagram of a second portion of a server file input/output (I/O) component of one embodiment, demonstrating the steps and processes involved in processing file I/O messages.

FIG. 11 is a schematic diagram of a server informational component of one embodiment, demonstrating the steps and processes involved in processing an information request message.

FIG. 12 is a schematic diagram of a server action component of one embodiment, demonstrating the steps and processes involved in processing an action message.

FIG. 13 is a schematic diagram of a repository component of one embodiment, illustrating the components of the protected objects central repository.

FIG. 14 is a simulated screen of one embodiment showing details about servers for a selected region.

FIG. 15 is a simulated screen of one embodiment showing an overview of a selected server.

FIG. 16 is a simulated screen of one embodiment showing the status of a selected server.

FIG. 17 is a simulated screen of one embodiment showing a list of events that have occurred on a web catalog of a selected server.

FIG. 18 is a simulated screen of one embodiment showing a list of files that have been altered on a web catalog of a selected server.

FIG. 19 is a simulated screen of one embodiment showing a change log of the various generations of a web catalog of a selected server.

FIG. 20 is a simulated screen of one embodiment showing a Mini Browser that displays an image of a web page as it currently exists in a web catalog of a server.

FIG. 21 is a simulated screen of one embodiment showing the contents of a file as it. currently exists in a web catalog of a server.

FIG. 22 is a simulated screen of one embodiment showing a status of a group of objects of a web catalog of a selected server.

FIG. 23 is a simulated screen of one embodiment showing a file comparison of a protected version of a file compared to an altered version of a file.

FIG. 24 shows a flow chart of a process in accordance with the present invention.

FIG. 25 shows a conceptual diagram of a computer hardware system in accordance with the present invention.

Corresponding reference characters indicate corresponding parts throughout the several views. The exemplary embodiments set forth herein are not to be construed as limiting the scope of the invention in any manner.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail to avoid unnecessary obscuring of the present invention.

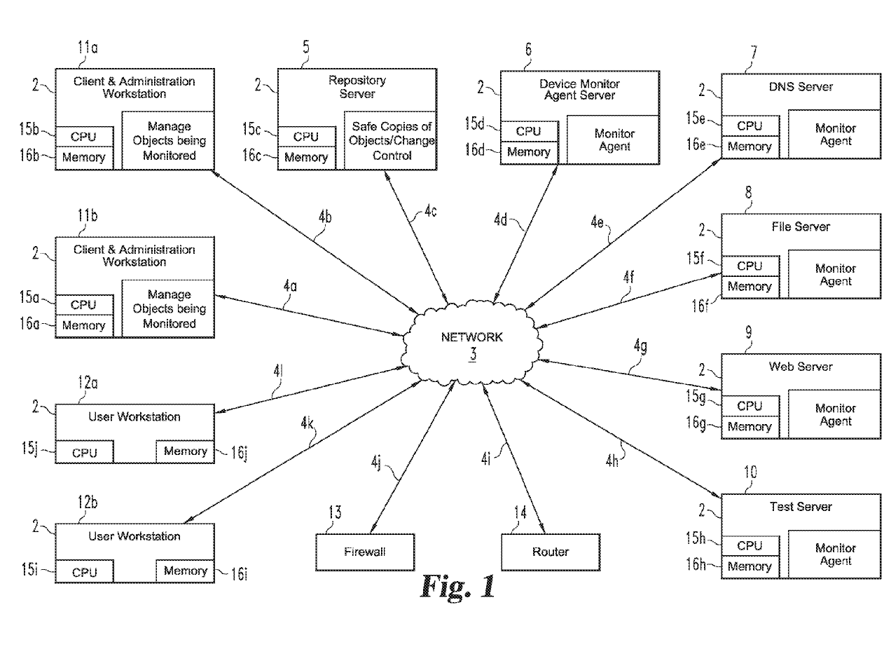

Thus, all the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

One embodiment of the present invention includes a unique system for maintaining integrity of files or data. FIG. 1 is a diagrammatic view of computer system 1 of one embodiment of the present invention. Computer system 1 includes computer network 3. Computer network 3 couples together several computers 2 and devices 13 and 14 over network pathways 4. More specifically, system 1 includes several servers, namely Repository Server 5, Device Monitor Agent Server 6, DNS Server 7, File Server 8, Web Server 9, and Test Server 10. System 1 also includes Firewall 13, Router 14, Client & Administration Workstations 11a and 11b, and User Workstations 12a and 12b. While computers 2 are illustrated as being a client or a server, it should be understood that any of computers 2 may be arranged to include both a client and server, just a client, or just a server. Furthermore, while ten computers 2 are illustrated, more or fewer may be utilized in alternative embodiments.

Computers 2 include one or more processors or CPUs (15a, 15b, 15c, 15d, 15e, 15f, 15g, 15h, 15i, and 15j, respectively) and one or more types of memory (16a, 16b, 16c, 16d, 16e, 16f, 16g, 16h, 16i, and 16j, respectively). Each memory 16a, 16b, 16c, 16d, 16e, 16f, 16g, 16h, 16i, and 16j includes a removable memory device, which is not shown to preserve clarity. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or otherwise) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD); a magnetically encoded hard disc, floppy disc, tape, or cartridge media; or a combination of any of these memory types. Also, each memory may be volatile, nonvolatile, or a hybrid combination of volatile and nonvolatile varieties. Although not shown to preserve clarity, network devices such as Firewall 13 and Router 14 can also include one or more types of memory, such as those that store device configurations.

Computer network 3 can be in the form of a Local Area Network (LAN), Municipal Area Network (MAN), Wide Area Network (WAN), such as the Internet, a combination of these, or such other network arrangement as would occur to those skilled in the art. The operating logic of system 1 can be embodied in signals transmitted over network 3, in programming instructions, dedicated hardware, or a combination of these. More or fewer computers 2 can be coupled together by computer network 3.

In one embodiment, system 1 operates as a data integrity system at one or more physical locations with Repository Server 5 being configured as a server for maintaining safe copies of objects and managing change control to those objects, Device Monitor Agent Server 6 being configured as a server with a monitor agent for monitoring network device data integrity of devices such as Firewall 13 and Router 14, and the remaining servers (DNS Server 7, File Server 8, Web Server 9, and Test Server 10) being configured as their respective server type and having a monitor agent to monitor data integrity. It should be understood by one in the computer software art that various other server arrangements are possible, such as one or more servers acting as both a File Server and a Web Server, one or more servers acting as both a Repository Server and a Monitor Agent. Server, to name a few non-limiting examples. Various other server types could be present, and some of the server types shown in system 1 could be missing, and still be within the spirit of the invention.

User Workstations 12a and 12b are used by end users for various purposes. Client & Administration Workstations 11a and 11b can be used to view and manage the objects being controlled by Repository Server 5 and being monitored by the Monitoring Agents of Servers 6, 7, 8, 9, and 10. Typically applications of system 1 would include many more User Workstations 12a and 12b, and/or many more Client & Administration Workstations 11a and 11b, at one or more physical locations, but only a few have been illustrated in FIG. 1 to preserve clarity.

System 1 can be used for various purposes where maintaining and protecting objects is useful. Some non-limiting examples include file/data integrity, disaster recovery, business continuity, automatically loading software onto multiple machines, monitoring server farms, monitoring DNS servers, monitoring static databases, monitoring database or application executables and/or configuration files, configuration management, patch management, and/or provisioning of wireless devices.

One embodiment for implementation with system 1 is illustrated in flow chart form as procedure 17, which demonstrates a high level process for maintaining data integrity on computers, and/or on devices such as switches, routers, and firewalls. In one form, procedure 17 is at least partially implemented in the operating logic of system 1. Procedure 17 begins with a user using a Client & Administration graphical or command line utility to define 17 the objects to be protected and several environmental thresholds to be monitored. A unique digital signature is generated 19 and placed in the Central Repository along with a compressed snapshot of the object(s). The digital signature can be an MD5, SHA1, or other type of digital signature or unique identifier, as a few non-limiting examples.

The Monitor Agent Component begins monitoring 20 the system in real time. If the monitor is triggered 22, the Repository Server attempts to confirm object integrity 24. If the Repository Server confirms changes to the digital signature of one or more objects 26, the corrupted objects are quarantined in the Central Repository 30 and the protected objects are then restored from the Central. Repository 32. If the Repository Server is not receiving 28 a heartbeat from one or more object containers, the Repository Server generates an alert 36 to the administrator. As monitoring continues 34, the process repeats by Monitor Agent continuing to provide real-time protection 20.

The Monitor Agent Component

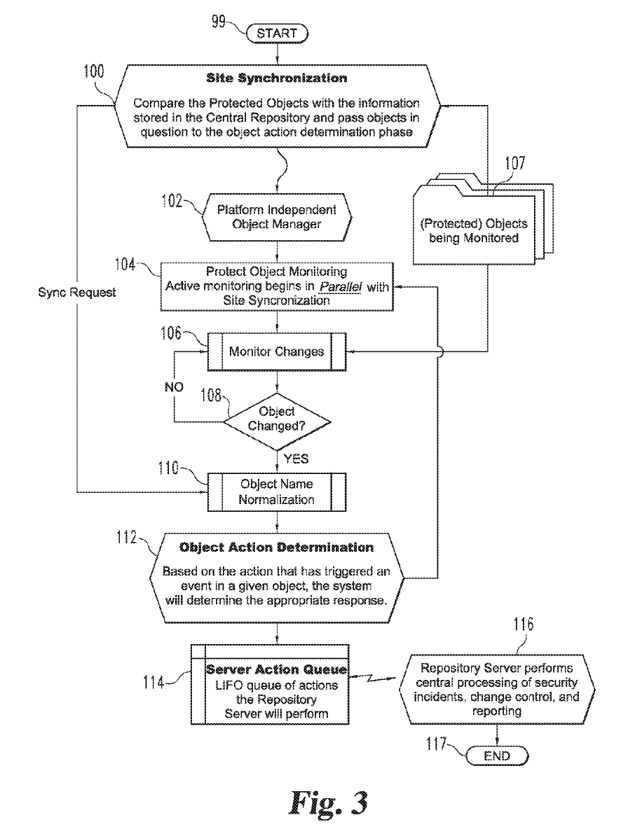

Referring now to FIG. 3, procedure 99 demonstrates a process for synchronizing and monitoring objects. In one form, procedure 99 is at least partially implemented in the operating logic of system 1. The Monitor Agent component is initiated using a layer known as the “Platform Independent Object Manager” 102. Once the Monitor Agent has determined the operating parameters it initiates parallel threads for “Site Synchronization” 100 and Active Monitoring 104.

While monitoring the system 106, the protected objects are being watched 107 for any type of change event 108 including modifying, renaming, moving, adding or deleting objects. If any of these events occur, the Monitor Agent responds by first Normalizing 110 the name of the effected objects. This normalization translates an object's name into a form that is recognizable by the Repository Server component regardless of its host platform. Having normalized the names, the “Object Action Determination” is triggered 112 to determine the appropriate course of action to take. As a few non-limiting examples, added objects will be removed, modified objects will be replaced, and deleted objects will be restored. The corresponding action message is then placed in the Server Action Queue 114 and the Repository Server component is triggered 116 to process the request.

Platform Independent Object Manager

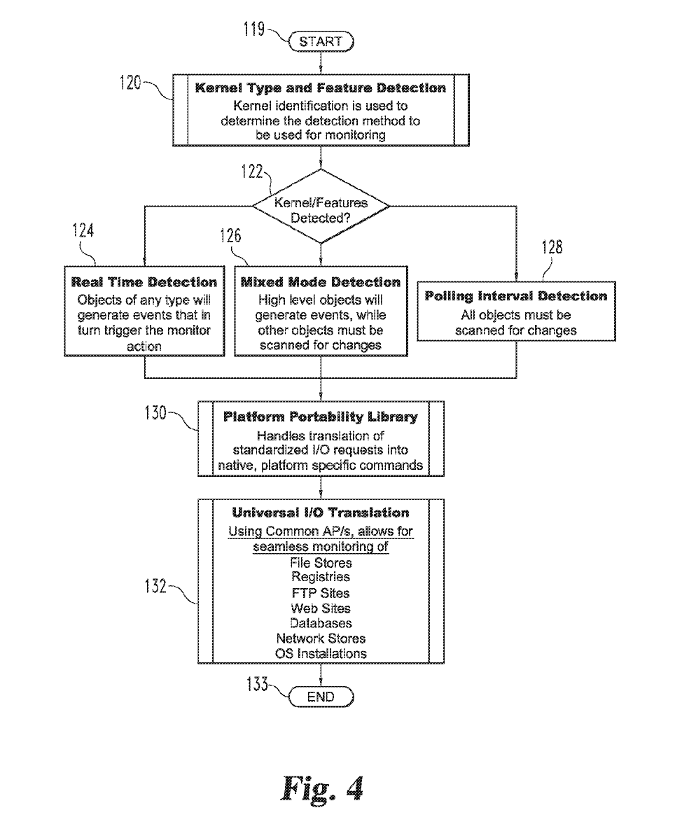

As shown in FIG. 4, procedure 119 illustrates the Platform Independent Object Manager layer that is used to establish three (3) primary elements that control the remaining functionality path of the Monitor Agent: “Kernel Type and Feature Detection”, “Platform Portability Library”, and “Universal I/O Translation”. In one form, procedure 119 is at least partially implemented in the operating logic of system 1. Kernel Type and Feature Detection 120 determines the monitoring mode 122 to use based on the Platform, Operating System and specific Kernel in use.

In Real-Time Mode 124, the Monitor Agent can react to any event that happens on each individual object. This is of course the fastest and most accurate means of monitoring a system. In Mixed Detection Mode 126, high level objects such as Tree or Directory Objects can trigger an event in real-time, and then the Monitor Agent will scan children of the object to determine which object(s) have actually been tampered with. In Polling Interval Detection Mode 128, all objects are scanned at a predefined interval in order to verify that they are authentic.

Platform Portability Library 130 translates all standardized I/O requests into native platform specific commands. This layer provides seamless portability between operating platforms.

Universal I/O Translation 132 is used to provide common APIs for the monitoring of multiple Container types including File Stores, Registries, FTP Sites, Web Sites, Databases, Network Stores, and OS Installations.

Site Synchronization

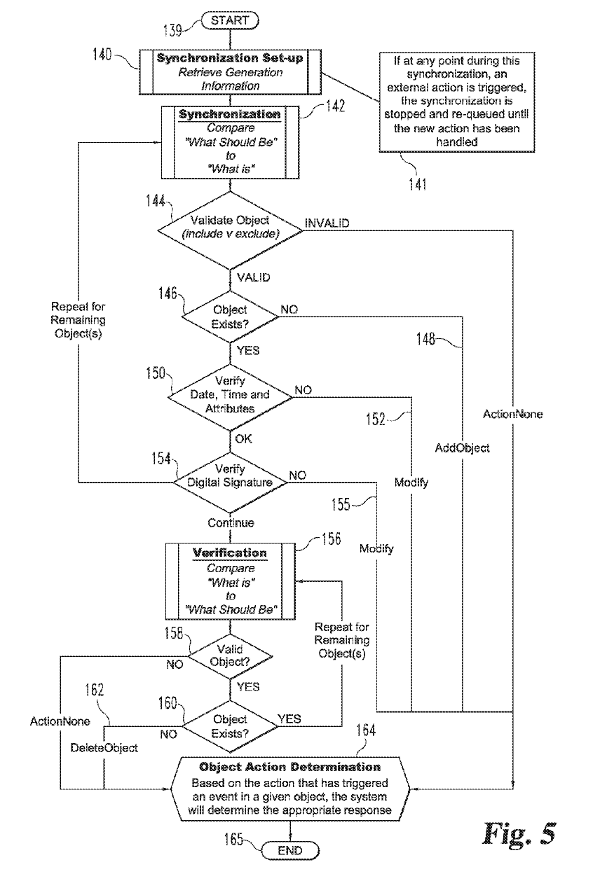

As shown in FIG. 5, procedure 139 illustrates the Site Synchronization process which is responsible for comparing the stored baseline of the protected objects against the actual protected objects. In one form, procedure 139 is at least partially implemented in the operating logic of system 1. The Site Synchronization process is accomplished in two phases, Synchronization and Verification.

After Synchronization set-up 140, Synchronization performs a comparison 142 between Stored Authoritative Copy (SAC) in the Protected Object Central Repository with the actual object that is being protected. First, the Monitor Agent determines 144 if the object is an “included” object in the protected group or container. If so, the Monitor Agent verifies that the object physically exists 146. If it does not, an “AddObject” message is sent 148 to Object Action Determination 164. If the object does exist, the stored attributes of the object, such as size, date and time, are compared 150 to the physical attributes. If these do not match, a “Modify” message is sent 152 to Object Action Determination 164. Otherwise, the stored digital signature is compared 154 against the physical digital signature. If the digital signature fails, a “Modify” message is also sent 155 to Object Action Determination 164. Once any requested objects are processed, the Verification phase begins 156.

Verification is the reverse comparison of the Synchronization phase. Each object that physically exists is compared against the SAC. If the physical object's container is supposed to be monitored 158, the Monitor Agent then verifies that the physical object exists in the SAC 160. If an object is not found to have a matching SAC, a “DeleteObject” message is sent 162 to Object Action Determination 164.

If at any time during Site Synchronization another Integrity-Compromising Event is fired by the active monitoring thread, the Site Synchronization is stopped, and re-queued for reprocessing 141.

Object Action Determination

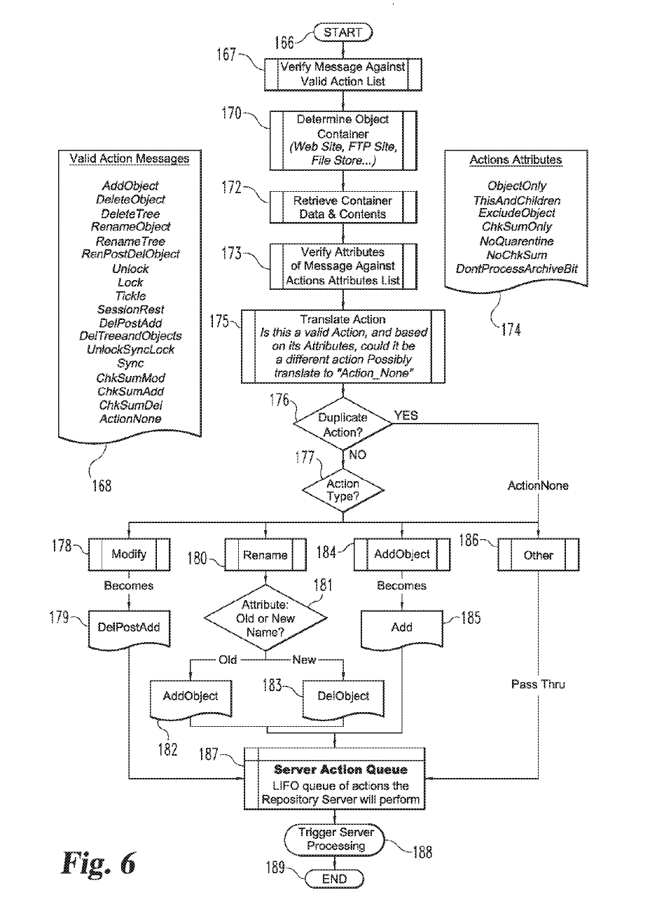

When monitoring a large number of objects, it is possible for a single integrity-compromising event to generate many messages. As shown in FIG. 6, procedure 166 illustrates the Object Action Determination (OAD) process which reduces the number of messages to be processed to accomplish the same goal. In one form, procedure 166 is at least partially implemented in the operating logic of system 1. Messages from the Monitor Agent to the Repository Server are passed through the OAD. First, each message is verified 167 against the Valid Message list 168. Once a message is determined 170 to be a valid message for the Container Type being monitored. 172, the attributes 174 of the message are verified. Now that the message and its attributes are known to be valid 175, the Action Queue is searched for an existing action so as to discard any duplicates 176. Lastly, certain actions are translated into a series of actions or a more fitting action 177 based on its attributes or on actions already queued. Here are some non-limiting examples. If the action type is Modify 178, it is translated to DelPostAdd 179. If the action type is Rename 180, and the attribute had an old name, it is translated to AddObject 182. If the action type is Rename 180, and the attribute had a new name, it is translated to DelObject 183. If the action type is AddObject 184, it is translated to Add 185. Other actions 186 are passed through. These new, translated actions are then resubmitted to the Server Action Queue 187 and server processing is triggered 188.

The Repository Server Component

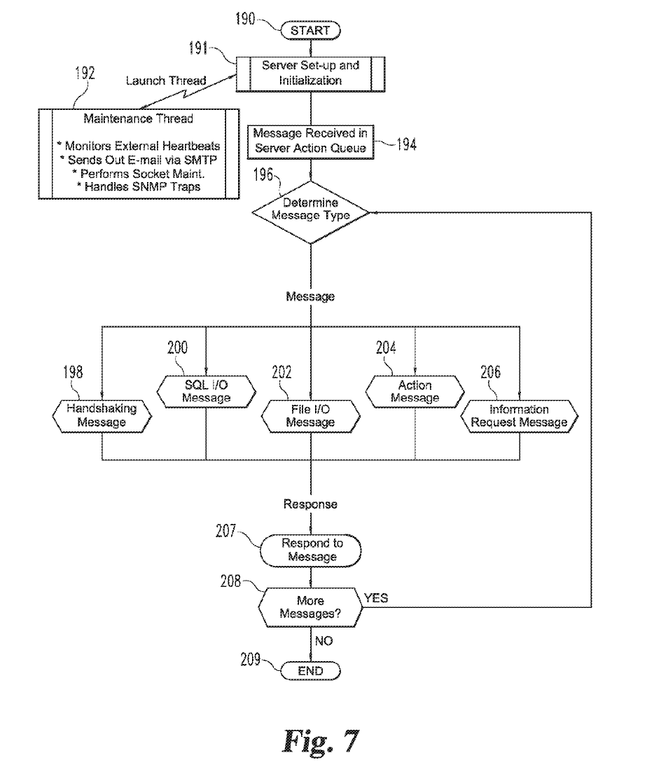

As shown in FIG. 7, procedure 190 illustrates the steps involved in receiving and processing messages. In one form, procedure 190 is at least partially implemented in the operating logic of system 1. Upon initialization of the Repository Server component 191, a Maintenance thread is launched 192 to perform much of the extraneous processing that is necessary throughout the life of the Repository Server. This Maintenance thread is responsible for monitoring the “heartbeat” of the any functioning Monitor Agent components, sending of any SMTP Emails, Socket Maintenance, or SNMP Traps. Having launched this thread, the Repository Server awaits notification that there is a new message in the Action Queue to process 194.

In one embodiment, the Repository Server is capable of determining 196 and processing five (5) categories of messages, “Handshaking” 198, “SQL I/O” 200, “File I/O” 202, “Action” 204, and “Informational Request” 206. Other variations are also possible. After determining the message type 196, a response to the message 207 is provided. The process repeats for each of the messages 208.

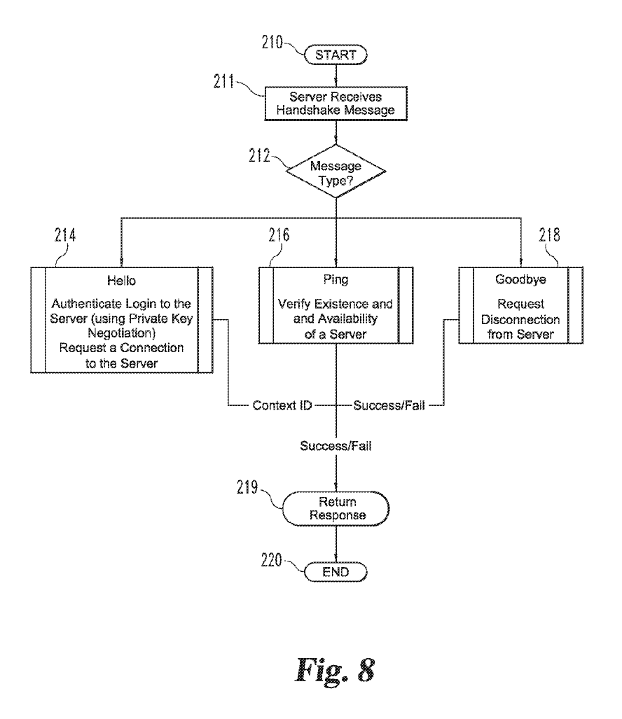

Continuing with FIG. 8, procedure 210 illustrates how the Repository Server processes a handshake message. In one form, procedure 210 is at least partially implemented in the operating logic of system 1. Handshaking messages 210 are used for establishing connections to the Repository Server by authenticating logins 214, such as using Private Key Negotiation, and for Disconnecting 218 a connection from a Repository Server. These messages also provide the ability to “ping” 216 a server to verify the existence and availability of a server. After processing the message, a response is returned 219.

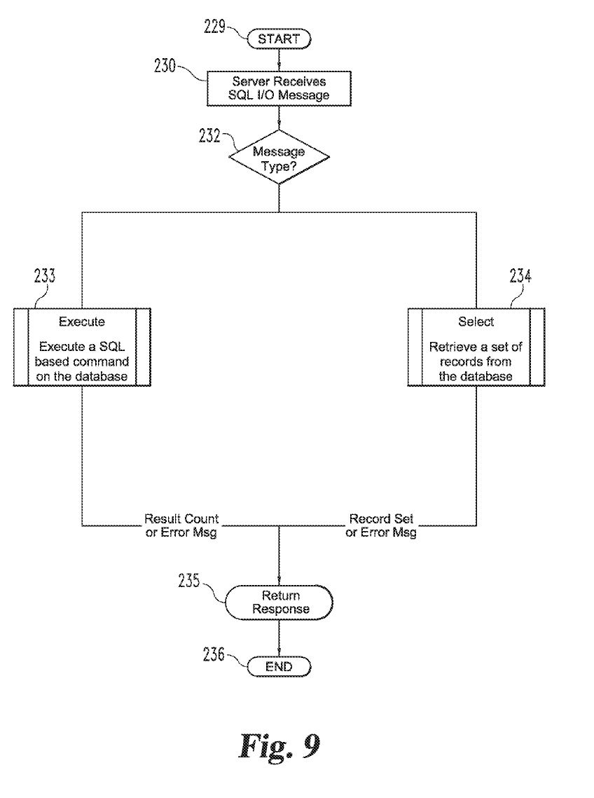

Continuing with FIG. 9, procedure 229 illustrates how the Repository Server processes a SQL I/O message. In one form, procedure 229 is at least partially implemented in the operating logic of system 1. SQL I/O messages 230 provide a universal interface for whatever type of Repository Database is in use. This allows the Repository Server access to a Repository Database on any platform supporting TCP/IP. In one embodiment, two (2) forms 232 of this message are available, Execute 233 and Select 234. After executing the Execute 233 message type, a result count or an error message is generated. After executing a Select 234, a record set or error message is generated. After processing the message, a response is returned 235.

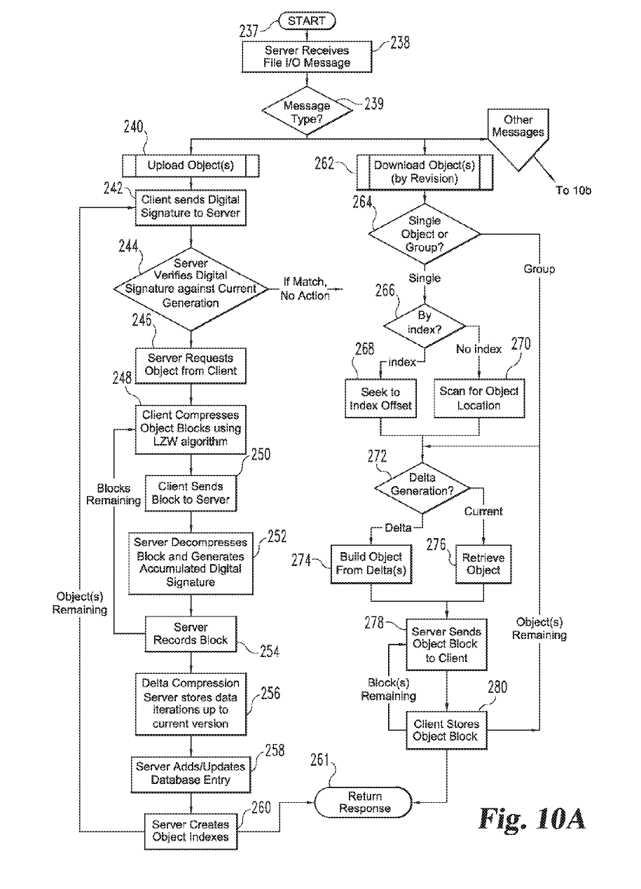

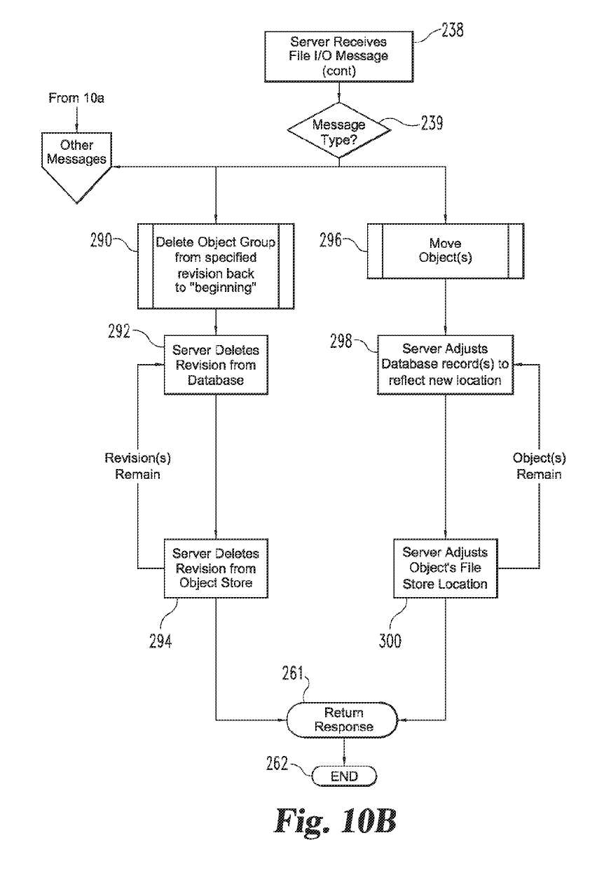

File I/O messages are used for all access to the Protected Object Central Repository. As shown on FIGS. 10A-10B, procedure 237 illustrates how the Repository Server processes File I/O messages. In one form, procedure 237 is at least partially implemented in the operating logic of system 1. File I/O messages are received by the repository server 238 and in one embodiment can be in one of four types 239: Uploads 240, Downloads 262, Deletes 290, and Moves 296.

As shown in FIG. 10A, with the Upload message type 240, the client sends the Digital Signature of a given object to the Repository Server 242. This Digital Signature is verified 244 against the SAC's Digital. Signature. Once confirmed as different, the Repository Server requests 246 that the Client transmits the object. Having received the transmit request, the Client separates the object(s) into multiple Blocks that are compressed 248 using an LZW lossless compression algorithm. Each Block in turn is transmitted 250 to the Repository Server. Upon receipt, the Repository Server decompresses 252 the block and generates an accumulated Digital Signature and records 254 this block to disk. Once all the blocks are received and the accumulated digital signature is verified, the Repository Server generates 256 a “Delta Compression” of the object(s). This Delta Compression is a copy of the most recent generation, and only the differences of the previous generation. Lastly, the Repository Server updates 258 the data in the Repository Database and creates 260 the appropriate Object Indexes.

With the Download message type 262, there are two forms of downloads, “Single Object” and “Object Group” 264. In the case of a single object request 266, the requestor can also specify an object index to aid in the location and retrieval of the object 268. If no index is provided, the Repository Server must do a sequential scan 270 to locate the specified object in. the requested generation. Having determined the requested object, or if an entire group is requested, the Repository Server continues 272. If the requestor is downloading the object from a previous generation, the current generation is regressed 274 using the Delta Compression data until the proper generation is achieved. If the requestor is downloading the object from the current generation, the object is retrieved 276. Having located the object in the desired generation, the Repository Server separates the object into LZW compressed blocks and transmits them to the Requestor 278. Once the requestor has received all of the blocks, they are reassembled into the object 280.

As shown, in FIG. 10B, with the Delete message type 290, the message deletes a given group of objects starting at the specified generation 292 and recursively deleting generations until it reaches the oldest generation stored 294. This delete occurs both in the repository database and in the Protected Object Central Repository.

With the Move message type 296, the message is used to physically relocate 300 a given object within the Protected Object Central Repository and then update the corresponding database entries 298.

After processing the file I/O message based on the File I/O message type, a response is returned 261.

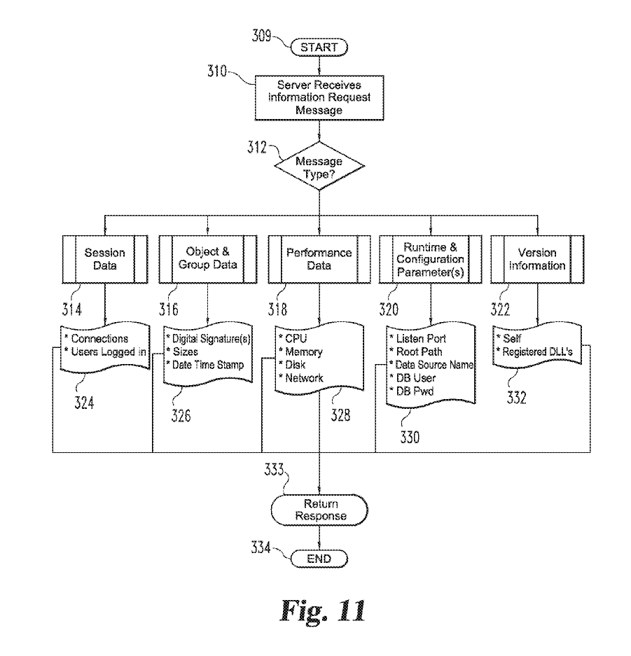

Continuing with FIG. 11, procedure 309 illustrates how Repository Server processes an Information Request Message. In one form, procedure 309 is at least partially implemented in the operating logic of system 1. Information Request Message provides access to various operation data on the Repository Server. In one embodiment, Repository Server can receive information request messages 310 in one of five (5) message categories: “Session Data” 314, “Object & Group Data” 316, “Performance Data” 318, “Runtime and Configuration Parameters” 320, and “Version Information” 322. Other variations are also possible.
Session Data 314 allows retrieval of connection statistics and User information 324.
Object & Group Data 316 allows retrieval of for Digital Signatures or object attributes (i.e.: size, data and time stamp) 326
Performance Data 318 allows retrieval of the performance attributes 328 for a given machine, including CPU Utilization, Network Bandwidth, Memory Usage and Disk PO.
Runtime and Configuration Parameters 320 establish 330 certain initialization. parameters. For example, Listen, Port, Root Path, Data Source Name, Database User, and Database Password.
Version information 322 include requests 332 specific to the Repository Server itself, including Version, and Registered DLLs.
After the Repository Server processes the Information Request Message, a response is returned 333.

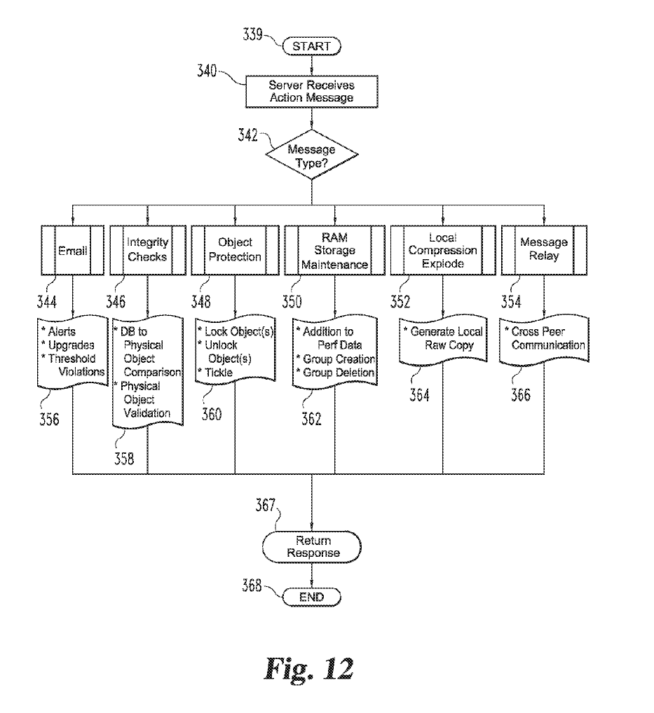

Continuing with FIG. 12, procedure 339 illustrates how Repository Server processes an Action Message. In one form, procedure 339 is at least partially implemented in the operating logic of system 1. Action messages are used to request that the Repository Server perform a given function 340. In one embodiment, valid action messages are separated into six (6) general categories 342, “Email” 344, “Integrity Checks” 346, “Object Protection” 348, “RAM Storage Maintenance” 350, “Local Compression Explode” 352, and “Message Relay” 354.
Email 344—All email type communications are handled 356 here, including Alerts, Upgrades, and Threshold Violation Notices.
Integrity Checks 346—These messages are used 358 for spot-checking the Repository Server and the Protected Object Central Repository for any potential corruption of the data or indexes.
Object Protection 348—This collection 360 is one of the most used message categories in the Repository Server. It is from here that objects and object group can be Locked and UnLocked. Also included in this set is a. “Refresh” message used to request that the Repository Server refresh the information that is in RAM with information from the Protected Object Central Repository and Repository Database.
RAM Storage Maintenance 350—While running, the Repository Server maintains 362 a memory copy of various operating parameters and performance statistics to monitor. This message group is used in the defining, modifying, and deleting of these parameters.
Local Compression Explode 352—To generate 364 a local disk based copy of a given object on the Repository Server, a “Local Compression Explode” is used.
Message Relay 354—These messages are tailored to distributing 366 communications between peers within the system. It is often necessary for the client to communicate with another agent in the course of operation. These relay messages allow for this peer-to-peer communication to take place.
After the Repository Server processes the Action Message, a response is returned 367.

Protected Object Central Repository

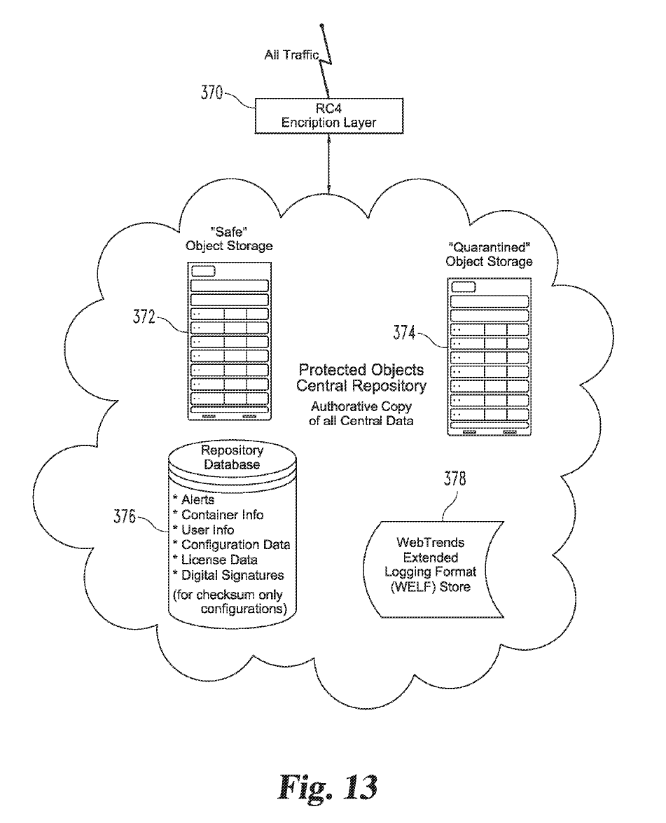

Continuing with FIG. 13, the Protected Object Central Repository is the storage center of the System Integrity Guardian universe. All communication to and from the Protected Object Central Repository are passed through an RC4 Encryption layer 370. In one embodiment, contained within the Protected Object Central Repository are the “Safe Object Store” 372, “Quarantined Object Store” 374, “Repository Database” 376, and the “WebTrends™ Extended Logging Format (WELF) Store” 378.

Safe Object Store 372 is where the Stored Authoritative Copy (SAC) of all protected objects is kept. It is here that the integrity and non-repudiation of the objects is guaranteed. This is a multi-generation store containing not only the most recent version/generation of an object; but also the previous Delta. Compressed generations. All objects are verified using both the physical attributes and a Digital Signature.

Quarantined Object Store 374 is similar to the Safe Object Store in its construction and functionality, but differs in its purpose. This store is used exclusively for the holding of objects that have been compromised in some way. By maintaining an isolated replica of these objects, an administrator can later examine them, in complete safety, in order to help derive the cause or purpose of the contamination, without affecting the original environment.

Repository Database 376 contains much of the data essential to the protection of the objects and the configuration of the system. Included in this data are “Alerts”, “Event Logging”, “Object Container Data”, “User Information”, “System Configuration Data”, “License Data”, and the “Digital Signatures”.

WebTrends™ Extended Logging Format (WELF) 378 is an industry-standardized format for representing Internet intrusion traffic and activity. This data can then be analyzed by various Commercial Off The Shelf (COTS) packages in order to monitor network health, server stability and data integrity. Other logging formats could also be used.

The Client Component

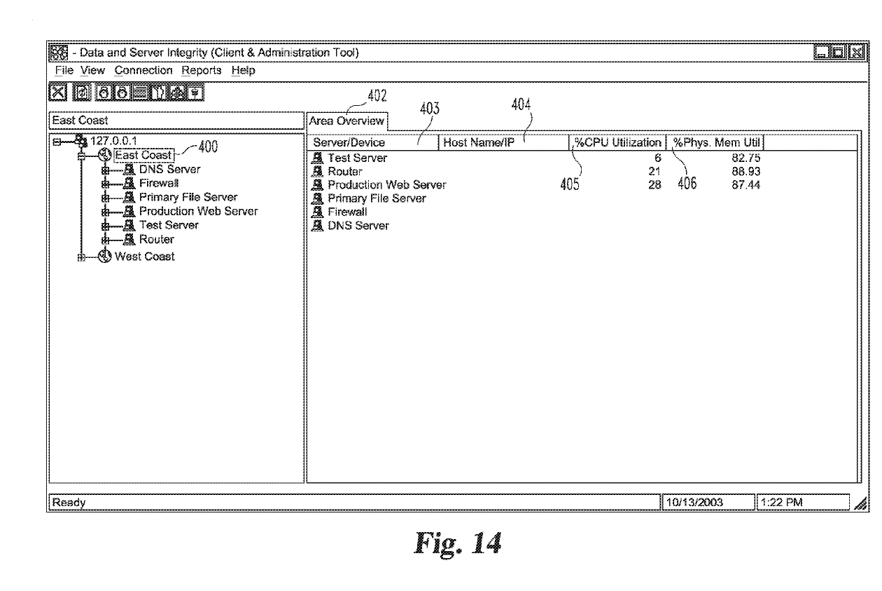

The Client component is the user interface for administering the System Integrity Guardian environment. Through this client interface, an administrator can determine which servers to protect, and which objects (directories and/or files) to protect (or not) within said server. Also with the Client component, the administrator can define what actions will be taken when an event that breaches integrity occurs. This can include a range of options from just logging the event up to quarantining the effected object(s) and then either removing any undesired object or replacing it with an authoritative copy from the Protected Object Central Repository. The Client interface can also be used to define and view various computer system performance criteria such as CPU utilization, Bandwidth usage, Storage Statistics and the like Examples of some of these features will be illustrated in FIGS. 14-23.

FIG. 14 depicts an example of details displayed about the currently registered servers for the selected region/group. The Area Overview tab 402 provides details about servers in the EastCoast 400 group. For example, the Server/Device 403, Host Name/IP 404, % CPU Utilization 405, and % Physical Memory Utilization 406 attributes of each server in EastCoast 400 group are displayed.

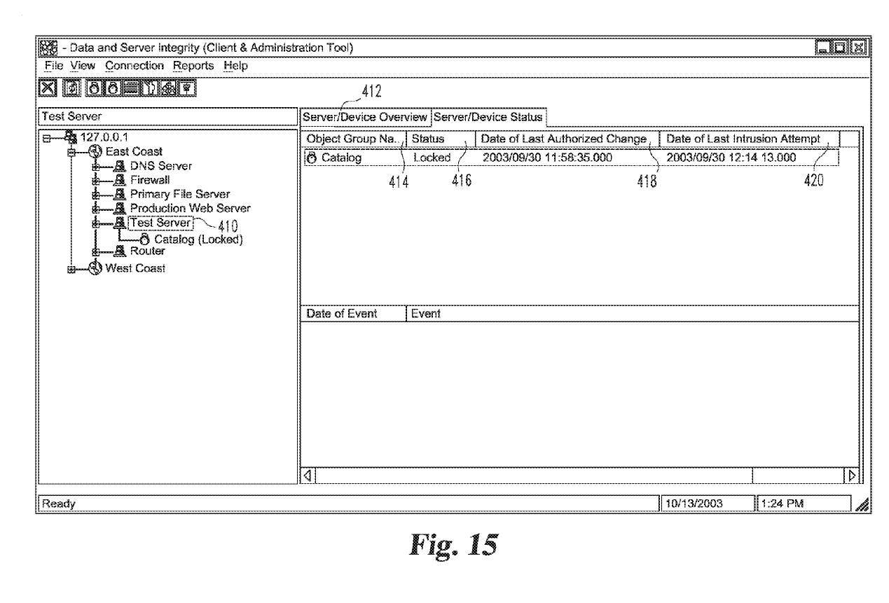

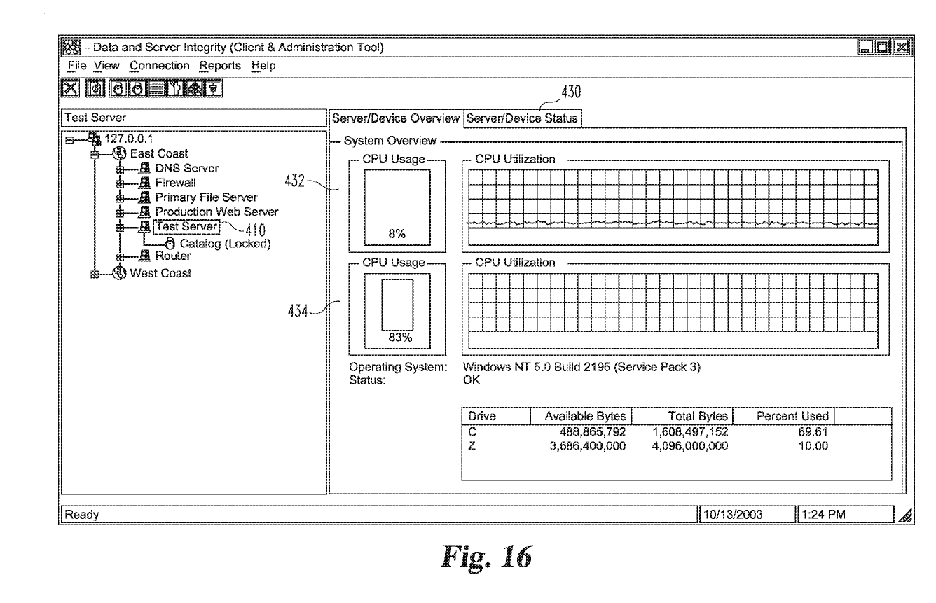

As shown in FIGS. 15 and 16, details about a particular server can be displayed. For example, FIG. 15 illustrates a Server/Device Overview tab 412 displaying Object Group Name 414, Status 416, Date of Last Authorized Change 418, and Date of Last intrusion Attempt 420 attributes for the selected Test Server 410. As shown in FIG. 16, the Server/Device Status tab 430 illustrates the CPU usage 432 and Memory Usage 434 attributes of the selected Test Server 410.

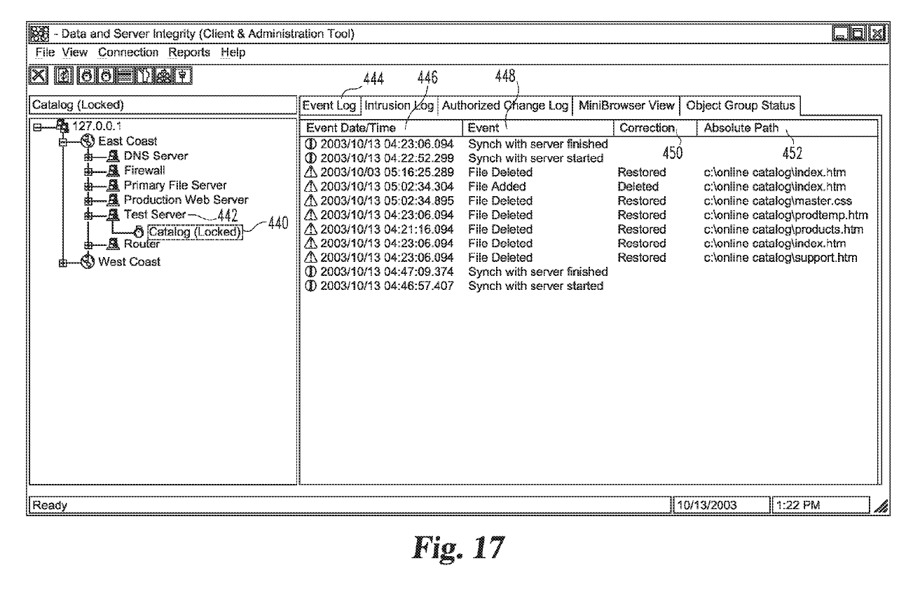

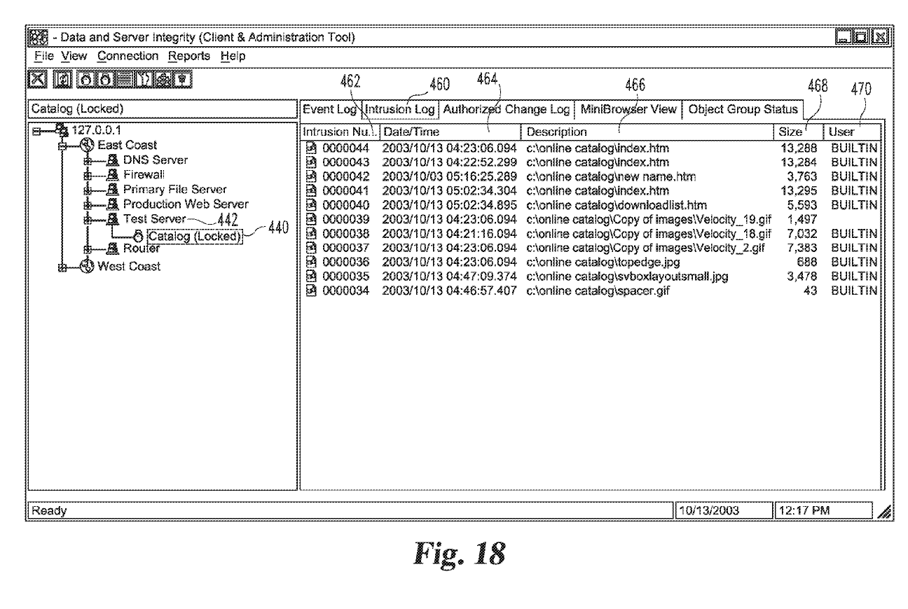

As depicted in FIG. 17, the Event Log tab 444 illustrates a list of events that have occurred on the selected Catalog 440 on Test Server 442 including the date and time of the event 446, the event 448, the correction 450, and the absolute path 452. The Intrusion Log tab 460, similar to that depicted in FIG. 18, displays a listing of any files that have been altered in some way, and provides an administrator with the ability to view the contents of the quarantined contents. In this example, several attributes are displayed in the Intrusion Log for Catalog 440 of Test Server 442, such as the Intrusion Number 462, Date/Time 464, Description 466, Size 468, and User 470.

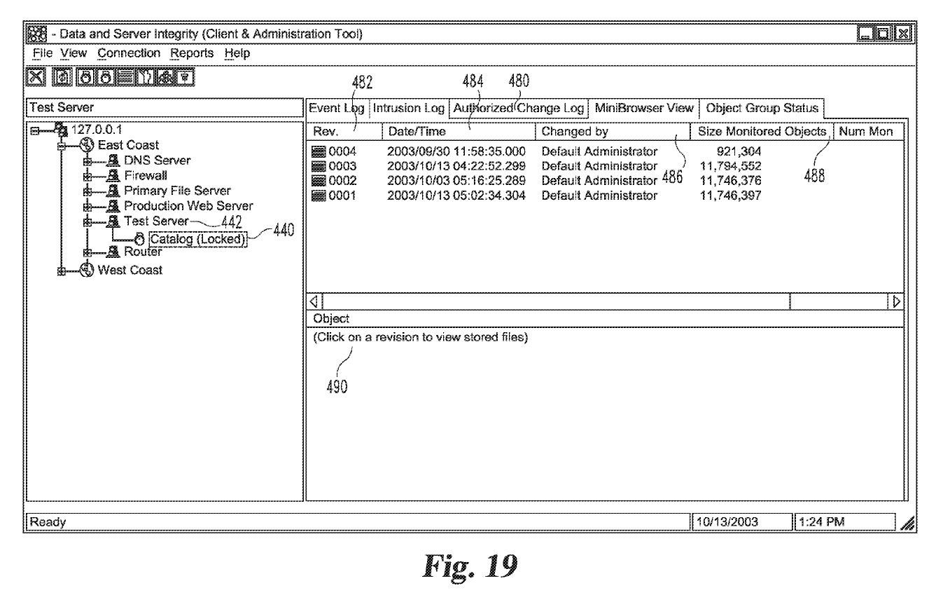

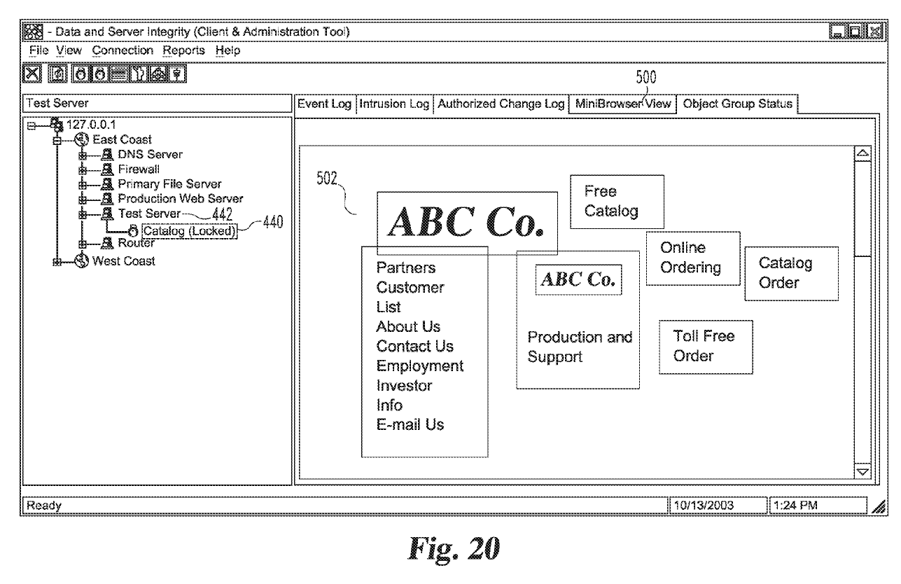

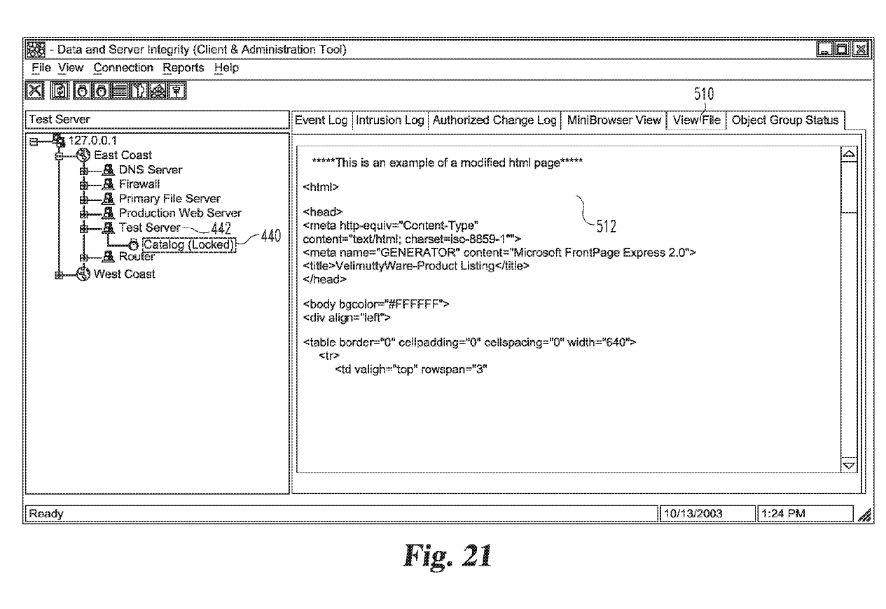

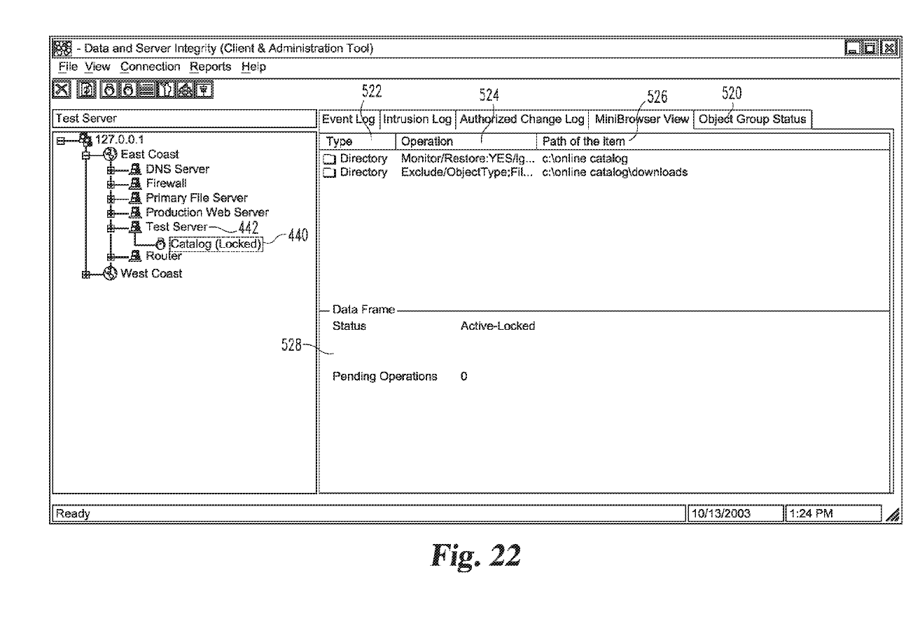

FIG. 19 is an example of an Authorized Change Log tab 480 that displays the various generations of the website that have been submitted. Included in the information is the revision 482, Date/Time 484, the person who made the change 486, and the size of the generation 488. The user can click on a revision to view stored files 490. An example of the Mini Browser tab 500 that displays an actual browser image 502 of the file as it currently exists in Catalog 440 on Test Server 442 is shown in FIG. 20. FIG. 21 shows the View File tab 510 displaying the contents of a selected tile on Catalog 440 on Test Server 442. As shown in FIG. 22, the Object Group Status tab 520 indicates various attributes indicating the status of the object group on Catalog 440 of Test Server 442, such as the Type 522, Operation 524, Path of the item 526.

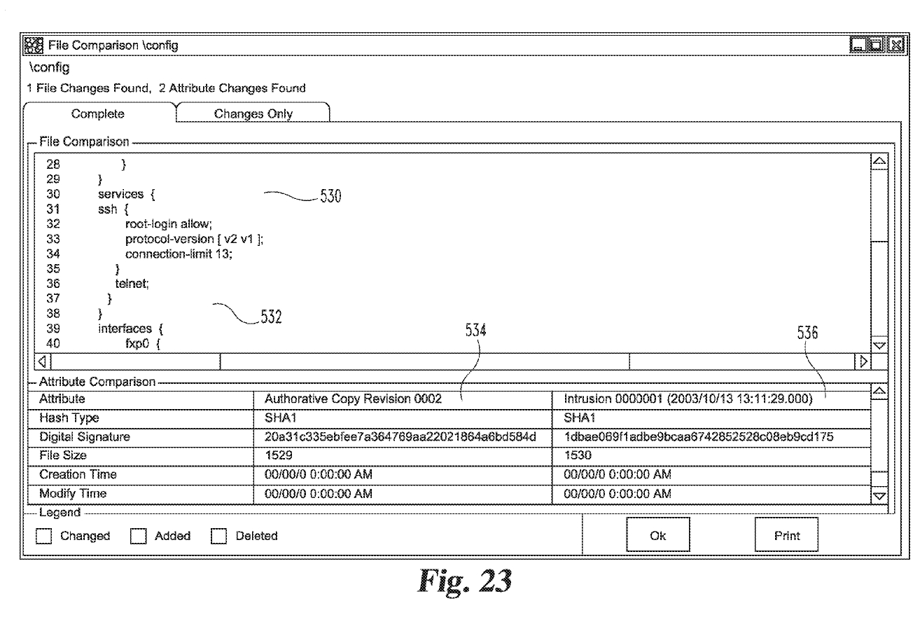

A user can also view a file comparison of one version of a file to another. FIG. 23 shows an example file with one version of the file displayed in window 530, highlights selected 532 visually indicating a line where a difference has occurred, and a list comparing the differences between the authoritative copy 534 and the altered copy 536.

The Client interface also offers a diverse array of reports to help an administrator to quickly surmise the condition and status of all computer systems being protected—without wasting precious time inspecting individual logs or multiple emails from each machine. In addition to this GUI interface, there is a Command Line Utility providing for non-graphical environments or Batch Processing.

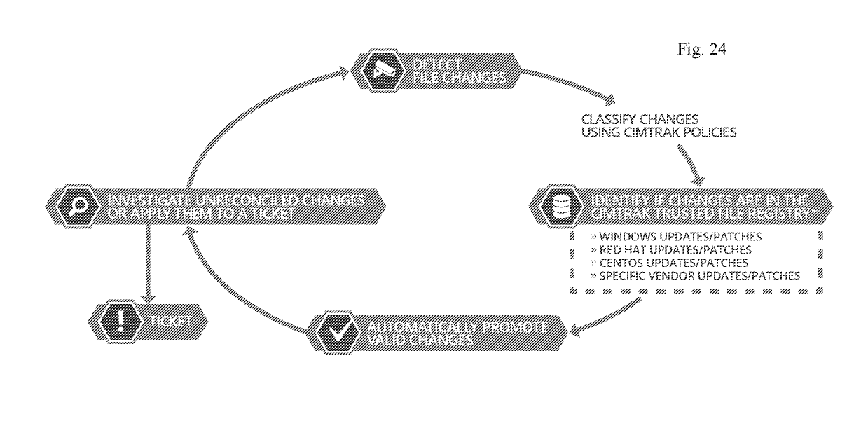

Referring now to FIG. 24, there is shown a flow chart of a process in accordance with the present invention. As illustrated in FIG. 24, in one exemplary embodiment, the system of the present invention generally comprises means for investigating unreconciled changes to an electronic object; means for determining whether said changes are preauthorized; automatically validating preauthorized changes; and segregating unauthorized changes for later determination.

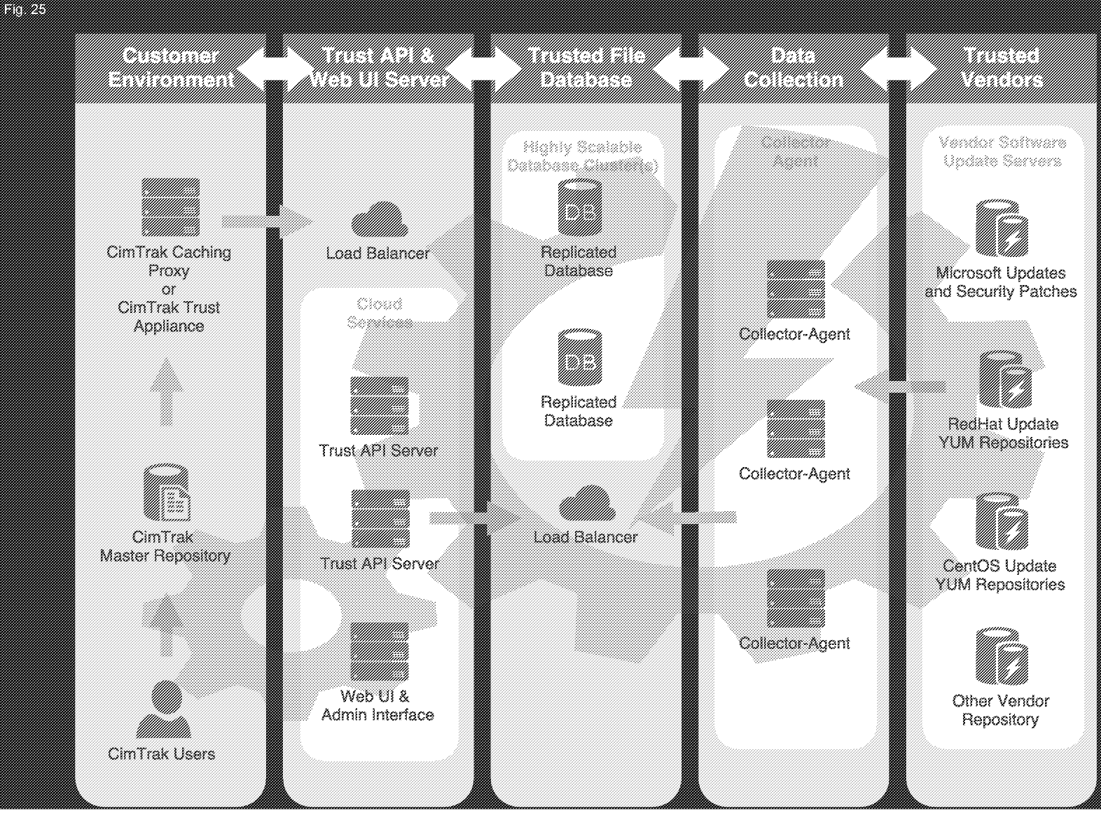

More specifically, a system in accordance with the present invention comprises a repository interface operative to make a copy of an original object and to store the object copy in a safe object storage, wherein the original object resides on a first server and the safe object storage resides a second server remote from the first server; a monitor agent interface operative to monitor the original object to detect a change in real time, said monitor agent interface further operative to classify a change as preauthorized or unknown in real time according to a set of predetermined rules and send a notification to the repository interface when the change is detected; wherein said repository interface is further operative to receive the notification from the monitor agent interface, identify an authorized change to the original object and automatically allow said change to the original object; said repository interface is further operative to receive the notification from the monitor agent interface, determine that an unknown change to the original object was unauthorized, and restore the original object on the first server using the object copy from the safe object storage in response to the change; wherein the repository interface is further operative to retain a copy of the changed object that can be reviewed after the object copy is restored from the safe object storage. A conceptual diagram of a computer hardware system in accordance with the present invention is shown in FIG. 25.

The exemplary embodiment of the present invention further comprises a method for maintaining server data integrity in an electronic data base, where said method comprises: receiving a selection of at least one object to be protected; providing a set of rules for classifying changes said object as preauthorized or unknown; generating a baseline copy of the object and storing the baseline copy in a safe object storage, wherein the at least one object resides on a first server and the safe object storage resides a second server remote from the first server; monitoring the object in real time; detecting an unauthorized modification to the object in real time; classifying said modification as preauthorized or unknown pursuant to said predetermined set of rules; in response to detecting an unknown modification, retrieving the baseline copy of the object from the safe object storage, and replacing the modified object on the first server with the baseline copy of the object; in response to detecting a preauthorized modification, maintaining the modification of the object on the first server.

In one exemplary embodiment, the method of the present invention comprises having the collector agent, on a regularly scheduled interval, read a configuration file that specifies high level information and vendor product specific parameters about each vendor's product for which information will be gathered. This configuration file will contain information such as the method for retrieving patches (HTTP vs YUM vs APT-GET, etc.), bounded time range of information for which to retrieve, vendor specific URIs, specific patches to exclude, and more. There is additional information in the configuration file which controls the behavior of the collector-agent, such as the polling interval, logging and error handling related settings, etc.

Based on the collector configuration data, the collector-agent will connect to each vendor's patch/update distribution system via a communication medium such as the internet and retrieve all of the patches/updates that have been generated by the vendor since the last polling interval.

There are several methods that are used to communicate with the remote vendor's patch/update distribution system. The method may involve simulating a web browser, and remotely navigating a website with appropriate credentials to download the required patches. In other circumstances, the method may require querying or syncing with a YUM repository or traversing another package manager such as pkg, apt-get, synaptic, and others. The collector-agent is designed in an extensible way to facilitate any type of package/update distribution mechanism. Variations of this embodiment may acquire the patches, updates & files in a variety of ways including:

a) A push mechanism whereby the patch/update/tiles are uploaded or transferred to the Trusted File Registry for analysis and categorization;

b) A trigger (such as an API call, web hook, or other trigger mechanism) which when invoked which will result in the Trusted File Registry fetching the patch/update/files from the authoritative source of the software vendor or OS provider;

c) A file upload mechanism via a webpage or FTP site, or other file transfer protocol which will be monitored by the Trusted File Registry and, upon the addition of a new patch/update/files, will perform. additional processing steps.

If patches/updates are found, the following steps occur:

a) The patch/update is downloaded.

b) If the patch is a zip file, compressed file, or archive of any type, then the file is uncompressed and any files that are embedded in the compressed file are expanded.

c) In some circumstances, a compressed file will contain other compressed files. In these circumstances, the collector-agent will recursively expand and extract all files, and any child archives, until no more files need to be extracted, uncompressed, or expanded.

d) The extracted files for the patch are now analyzed and key metadata for all of the resulting files are identified. These attributes include filename, original package name, patch identifier, SHA1 hash, SHA256 hash (and other hash methods may be configured), and other information.

e) Some patch and update files include specialized inventory files which describe the contents of the patch/update. In the event that this file exists, it will be parsed arid relevant information will be extracted from this inventory file. This file may be in a variety of formats, and individualized parsers are developed to accommodate for the various inventory file formats.

All metadata for each of the files in the patch/update/files are stored in a high transaction database which, in this embodiment, is referred to as the Collector-DB. The Collector-DB is a distributed database, which may be sql or nosql based. All metadata is replicated in multiple locations both in the cloud and on premise. The Collector-DB is designed to scale to handle increasing query loads. A load balancing mechanism or a Gossip Network Coordination Protocol shall be used to ensure that all the nodes that comprise the Collector-DB are in sync and properly replicating data. To ensure performance of the Collector-DB, tightly controlled primary keys and indexes are used to maximize the insert and query speeds.

In an alternative variation of this embodiment, the Collector-DB can be made available as a network appliance in which the entire database of metadata is provided offline as a network appliance. In this circumstance, a mechanism shall be implemented to allow this database to be synced with a remote “Master Collector-DB” via the internet or other network protocol. In addition, a manual update mechanism, such as via CD or DVD or other storage medium, will be made available, because some installations of the Collector-DB may be in an air-gapped environment, for which external internet access is not available.

In another alternative variation of this embodiment, the Collector-DB can be made available as a virtual machine in which the entire database of metadata is provided offline as a virtual appliance. In this circumstance, a mechanism shall he implemented to allow this database to be synced with a remote “Master Collector-DB” via the internet or other network protocol. In addition, a manual update mechanism, such as via CD or DVD or other storage medium, will be made available, because some installations of the Collector-DB may be in an air-gapped environment, for which external internet access is not available.

All access to the Collector-DB is via the FileInfo-Server subsystem. This system is responsible for controlling and marshaling access to the Collector-DB. It also exposes an API that can be used to query the Collector-DB or to insert data into the Collector-DB. Some of the main functions performed by the FileInfo-Server include but are not limited to:

a) querying if hash is found in the Collector-DB;

b) querying if bulk set of hashes are found in the Collector-DB;

c) querying extended information about a particular file or hash;

d) inserting new hash and metadata into the Collector-DB if it doesn't already exist;

e) deleting a set of hashes from the Collector-DB;

f) verifying login credentials or API key to control access into the Trusted File Registry:

g) leveraging information from the License Manager to determine if API keys have expired or not, and to validate login credentials;

h) performing API rate limiting;

i) maintaining a memory based cache of file hash and meta data. (This cache is high speed because it is not dependent on disk 110 and refreshes based on a LRU (least frequently used) algorithm, using time based expiration for its ejection strategy.); and

j) serving a web front end subsystem for allowing the user to query information from the Collector-DB without requiring the use of the API.

The present invention may also comprise a system including a License Manager subsystem having three primary components, a Licensing Database, an API Interface, and a Subsystem Web Subsystem.

The Licensing Database contains the authoritative list of users and valid API Keys including their associated expiration dates. In addition this database details the level of access and control of the Trusted File Registry data.

The API interface provides an abstracted method to add/update/delete users, add/update/delete API Keys, and methods to control privilege levels and other access related parameters.

The Web subsystem uses the License Database API subsystem in order to provide the administrator with a web based method of creating, controlling, and delegating access to the Trusted File Registry.

The system may further comprise a Hash-Scanner Subsystem is a tool that is used to scan a set of files or directories, and to upload their file hashes and meta data directly to the Trusted File Registry. This tool allows the administrator to perform multiple maintenance functions against the Trusted File Registry.

The system may further comprise a NIST Uploader. The NIST maintains a baseline of file hashes. This uploader allows this NIST data file to be parsed and combined with other relevant data to assist in the population of the Collector-DB.

The Trusted File Registry is a complex multi-node application. The Administrative Management Subsystem monitors this complex system for performance, disk and IO related issues, aggregates errors, performs logging, facilitates regular database maintenance activities, and other administrative functions that are needed to maintain a system of this complexity.

The architecture of an exemplary system in accordance with the present invention may include:

1) a Collector-Agent (Distributed on multiple secure servers both on premise and in the cloud);

2) a FileInfo-Server (Distributed on multiple secure servers both on premise and in the cloud) a) API Server b) Web Query Interface c) Local Cache;

3) a Collector-DB (Distributed on multiple secure servers both on premise and in the cloud);

4) a Licensing Manager (Distributed on multiple secure servers both on premise and in the cloud);

5) a Hash-Scanner;

6) a NIST-Uploader; and

7) an Administrative Management Subsystem.

Integration with CimTrak Integrity Suite

The Trusted File Registry will be adapted to integrate and receive information from other security software systems, where it can be further categorized to identify if it is associated with an OS, patch, or upgrade. The system as a whole will automatically mark certain files as suspect and unreconciled. These unreconciled files will be made available for the user to review and make a final decision regarding their disposition (threat or not). For example, the system may incluse Master Repository settings that allow a user to enter an API key for the Trusted File Registry. This API Key is the method by which the user gains access to the Trusted File Registry. Every API Key has an expiration date, and this date is determined based on the terms of the licensing agreement or order.

The system may further comprise an Autoreconciliation Mode. In this mode of operation, every change that is identified by any part of the system is automatically sent to the Trusted File Registry for validation. If it is determined that the file is trusted, then the file is automatically reconciled, accepted to be a good change via promotion to the authoritative baseline. In addition, any trusted files are automatically added to a special ticket, which is automatically created daily, to document all changes which were automatically reconciled.

The system may further comprise a Manual Reconciliation Method. In this mode of operation, the user may not wish to have changes reconciled automatically in real-time. In this circumstance, the user can navigate to the change reconciliation screen, and select multiple files (or all files), in bulk, and transmit them to the Trusted File Registry for validation. At this point the user can select all (or a subset) of the files that have been identified by the Trusted File Registry as trusted, and promote them to the authoritative baseline in order to reconcile the changes.

The system further includes means for users to manually check if a file is trusted by querying the Trusted File Registry. In this circumstance, the user is provided with a list of all of the possible files that match the respective hash, including other information such as source file, patch, vendor, and etc.

The system of the present invention may further include a ticketing subsystem to tightly integrate information from the Trusted File Registry; a caching mechanism for storing the results from the Trusted File Registry locally which reduces the load on the Trusted File Registry because it eliminates the need to query the same information twice, reduces bandwidth requirements, and ultimately generates faster results for the user; and additional reports to facilitate reporting of autoreconciled changes and high-level reconciliation summaries for management. Integration with other Security Tools

The present Trusted File Registry will be available for integration into a variety of security vendor software systems, and it may contain additional support subsystems such as a billing and extending licensing features.

While this invention has been described with respect to at least one embodiment, the present invention can be further modified within the spirit and scope of this disclosure. This application is therefore intended to cover any variations, uses, or adaptations of the invention. using its general principles. Further, this application is intended to cover such departures from the present disclosure as come within known or customary practice in the art to which this invention pertains and which fall within the limits of the appended claims.

1. A computer implemented method of identifying and classifying changes to software, said method comprising the steps of: determining a regularly scheduled interval for validating the software; providing a collector agent; having the collector-agent read a configuration file having information selected from the group consisting of the method for retrieving patches, bounded time range of information for which to retrieve, vendor specific URls, and specific patches to exclude that specifies high level information and vendor product specific parameters about each vendor's software product for which information will be gathered; based on the collector configuration data, having the collector-agent connect to each vendor's patch/update distribution system via a communication medium such as the internet, to retrieve all of the patches/updates that have been generated by the vendor since the last polling interval; and having the collector agent communicate with the remote vendor's patch/update distribution system.

2. A computer based system comprising: a Collector-Agent, Distributed on multiple secure servers both on premise and in the cloud; a FileInfo-Server, Distributed on multiple secure servers both on premise and in the cloud, having an API Server, a Web Query Interface, and a Local Cache; a Collector-DB (Distributed on multiple secure servers both on premise and in the cloud); a Licensing Manager (Distributed on multiple secure servers both on premise and in the cloud); a Hash-Scanner; a NIST-Uploader; and an Administrative Management Subsystem.

3. A system for maintaining server data integrity, said system comprising: a repository interface operative to make a copy of an original object and to store the object copy in a safe object storage, wherein the original object resides on a first server and the safe object storage resides a second server remote from the first server; a monitor agent interface operative to monitor the original object to detect a change in real time, said monitor agent interface further operative to classify a change as preauthorized or unknown in real time according to a set of predetermined rules and send a notification to the repository interface when the change is detected; wherein said repository interface is further operative to receive the notification from the monitor agent interface, identify an authorized change to the original object and automatically allow said change to the original object; said repository interface is further operative to receive the notification from the monitor agent interface, determine that an unknown change to the original object was unauthorized, and restore the original object on the first server using the object copy from the safe object storage in response to the change; wherein the repository interface is further operative to retain a copy of the changed object that can be reviewed after the object copy is restored from the safe object storage.

4. A method for maintaining server data integrity in an electronic data base, said method comprising: receiving a selection of at least one object to be protected; providing a set of rules for classifying changes said object as preauthorized or unknown; generating a baseline copy of the object and storing the baseline copy in a safe object storage, wherein the at least one object resides on a first server and the safe object storage resides a second server remote from the first server; monitoring the object in real time; detecting an unauthorized modification to the object in real time; classifying said modification as preauthorized or unknown pursuant to said predetermined set of rules; in response to detecting an unknown modification, retrieving the baseline copy of the object from the safe object storage, and replacing the modified object on the first server with the baseline copy of the object; in response to detecting a preauthorized modification, maintaining the modification of the object on the first server.
